(19) United States
(12) Patent Application Publication
(10) Pub. No.: US 2004/0040905 A1
(43) Pub. Date: Mar. 4, 2004

(54) Filter device, especially for a liquid

(76) Inventor: August Schmid, Schwerzenbach (CH)

Correspondence Address: WENDEROTH, LIND & PONACK, L.L.P., 2033 K STREET N. W., SUITE 800, WASHINGTON, DC, 20006-1021, US

(21) Appl. No.: 10/333,131

(22) PCT Filed: Jul. 3, 2001
(86) PCT No.: PCT/CH01/00413

(30) Foreign Application Priority Data
Jul. 17, 2000 (CH) 1412/00

(51) Int. Cl. B01D 25/32

(52) U.S. Cl. 210/488; 210/411; 210/450

(57) ABSTRACT

The filter device contains a stack of filter rings (2), preferably consisting of plastic. Each filter ring (2) contains a number of cams (3) which are distributed evenly over the face, and diametrically opposed recesses. When the cams (3) and the recesses of adjacent filter rings (2) lie flush on top each other, a gap (7) is formed between them. The gap openings of the filter element (8), which consists of several filter rings (2) layered on top of each other, can be cleaned efficiently by means of a back-flow device comprising nozzle bodies (70). The characteristics of the filter can be altered by selecting a filter gap with different filter rings and different filter stack heights.

The invention relates to a filter device according to the generic term of claim 1.

Filter devices and especially disc filters of various designs are prior art. Types of filter whose gap between discs is determined by the thickness of star-type intermediate layers made from metal may be suitable for oil, but not for purifying dirty water or similar.

Commercial sand filters are normally massive and heavy in execution because of the necessarily high volume of sand. There is also the problem with the latter that when back-flowing to clean the sand by forcing the water upwards from below that what are known as waterways are formed, the result of which is that the water flows almost without resistance through the channels thereby formed in the sand and the water pressure at the inlet nozzles is massively reduced. This means the sand is no longer consistently cleaned over its entire volume and this also leads to high water consumption.

The problem of the present invention consists in the creation of a filter for unpurified liquids which is intended to offer effective cleaning of the liquid with a simple construction and can also be easily cleaned.

The invention with which this problem is solved can be seen from the characteristics of the criterion in claim 1.

By this arrangement of a number of such filter rings layered on top of each other, these latter can be combined into filter packs of varying heights where they are very advantageously self-centring. The filter gap is determined mechanically by the dimensions of cams and recesses which engag with each other. This means that by pre-sel cting the filter gap and the height of the filter package, both the precipitation characteristics and the through-flow rate can be adapted precisely to the respective requirements.

### The drawings show design examples of the object of the invention and are described in more detail below. These show:

FIG. 1 a longitudinal section through a filter device according to invention with a back-flow device.

FIG. 2 a section of the nozzle body of the back-flow device according to FIG. 1,

FIG. 3 a top view of a disc part of the nozzle body according to FIG. 2,

FIG. 4 a side view of a filter ring of the device according to FIG. 1,

FIG. 5 a top view of the filter ring according to FIG. 4,

FIG. 6 a cut-out of the filter ring according to circle C in FIG. 4 on a larger scale,

FIG. 7 a section along the line A-A according to FIG. 5 with two filter rings lying on top of each other

FIG. 8 a longitudinal section through a filter device with rotating brush,

FIG. 9 a view of a brush with helically-arranged bristles,

FIG. 10 a longitudinal view of a variant of a filter device according to invention, and

FIG. 11 a longitudinal section of the filter device according to FIG. 10 in the cleaning position.

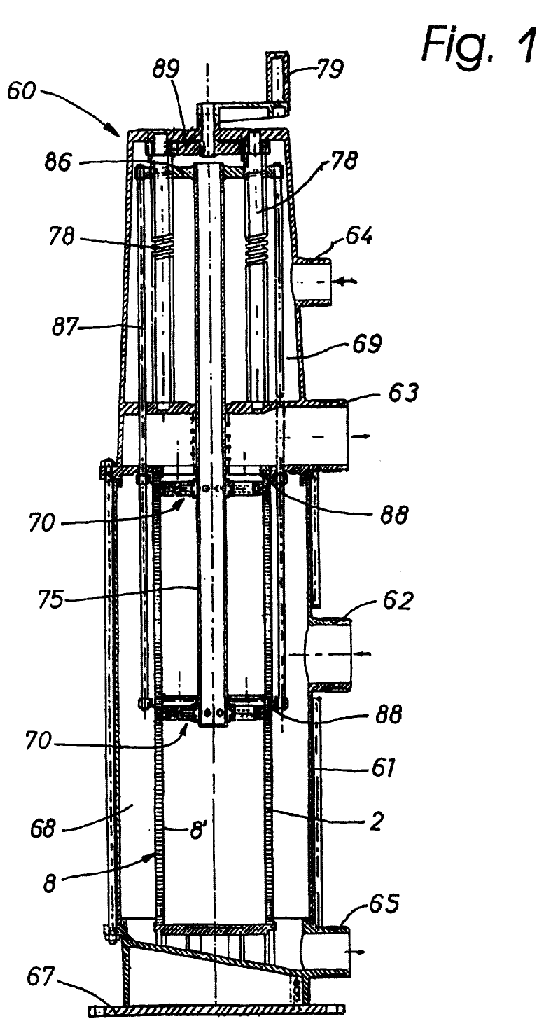

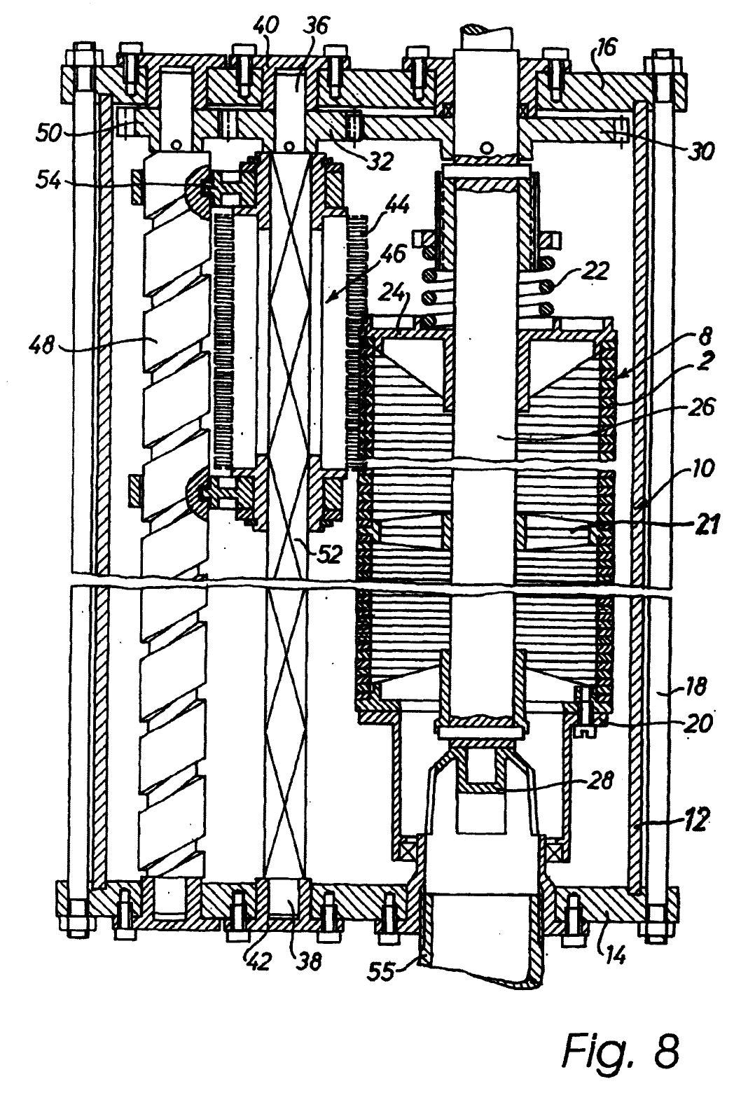

A filter element (8) of a filter device, especially a gap-type filter device, as can be seen from FIG. 1 or FIG. 8, is especially suited to filtration of contaminated water, such as for example the water in swimming pools. It can, however, also be used for other purposes. It has also been shown that for example, water mixed with chemicals, such as for example water mixed with dye, can be purified, with the dye being completely precipitated from the water.

According to invention the filter element 8 displays a number of filter rings 2 loosely stacked on top of each other, which are each designed in such a way that when layered they lie in a self-centring concentric arrangement on top of each other and form gaps 7 in between to allow liquid to pass through.

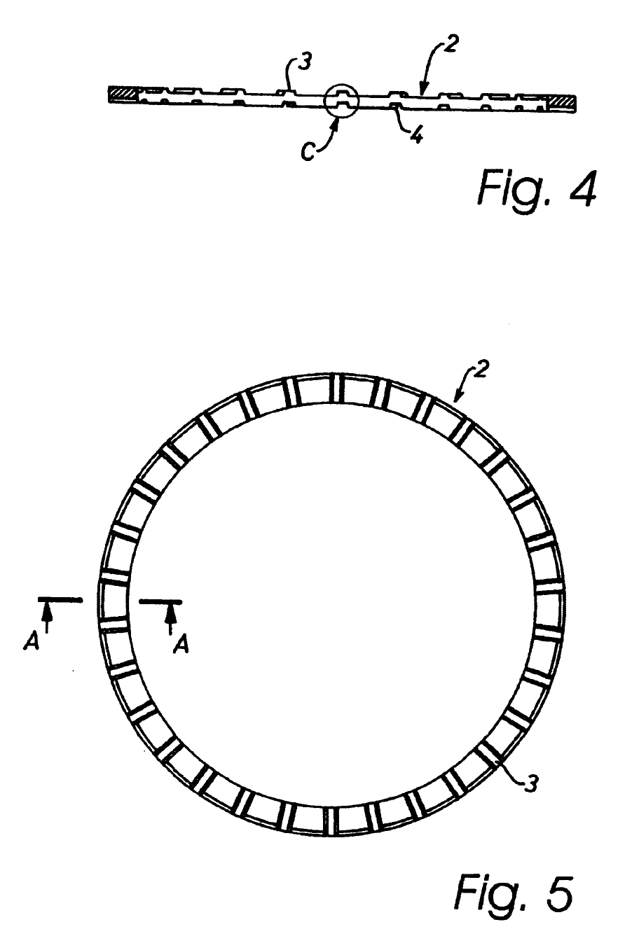

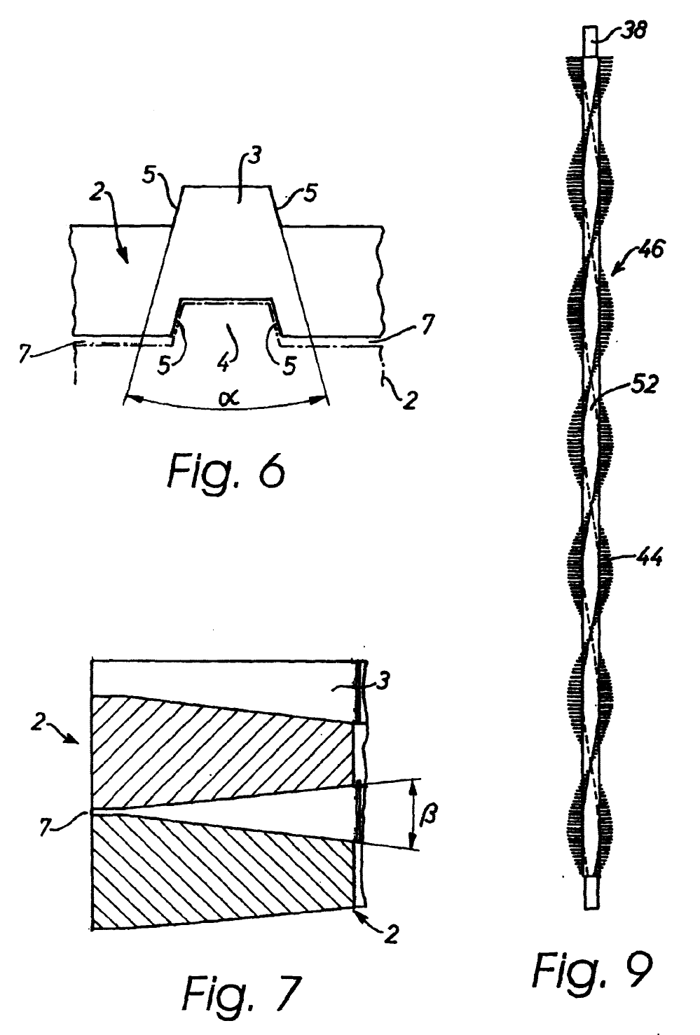

Each filter ring 2, according to FIG. 4 to FIG. 7, displays a number of cams evenly distributed over its area, for example thirty cams, and diametrically opposed recesses 4 of the same size. The cams 3 and the recesses 4 are laid out such that when stacked on top of each other the cams 3 lie flush in the recesses 3 [sic; 4] of the adjacent ring. The lateral areas 5 of the centring cams 3 and of the recesses 4 each have a sloping incidence of an acute angle α, preferably of some 30°. This allows stacks of filters 6 to be formed from the individual filter rings 2 which are independent of each other in variable heights where the filter rings 2 centre themselves with respect to each other, since several centring cams 3 and recesses 4 are provided which are pointing towards the centre of the ring.

When the filter rings 2 are laid concentrically on top of each other so that cams 3 and recesses 4 lie flush on top of each other, a filter gap 7 forms between every two cams of a filter ring. This filter gap 7 extends in the direction of the ring centre, as can be seen from FIG. 4. The aperture angle β, running in a plane at right angles to the longitudinal extension of the ring, is some 12°. The narrowest gap width can be between a few hundredths and a few tenth of a millimetre by selection of the filter ring design, depending on the desired filter property. The liquid to be filtered then flows from th outside of the ring towards the centre, with th impurities being precipitated on the outside of the ring.

As the result of the one-piece execution of these individual filter rings 2 made from plastic, preferably from a PVC or ABS material, these can be fabricated very economically in large quantities. Obviously these rings could also be made from a metal, e.g. from die-case aluminium.

FIG. 1 shows a filter device 60 with a filter element 8 in which according to invention a number of such filter rings 2 are laid on top of each other, where this filter element is surrounded by a tubular housing 61, between which a ring chamber 68 is provided. The housing 61 preferably has an inlet nozzle 62 at approximately half its height and an outlet nozzle 63 aranged on the upper end of the filter elemet 8. Also, for the back-wash, there is an additional inlet 64 above the outlet nozzle 63 and an outlet 65 provided on the lower end of the housing 61, which can be closed in normal operation by a valve, not shown in more detail. The otherwise sealed housing 61 has a pedestal 67 on its underside, by means of which it can be fastened to a floor or similar.

A very advantageous back-flow device is fitted to the filter element 8 in the frame of the invention by means of which the impurities deposited in the gaps 7 between the filter rings 2 can be completely flushed out.

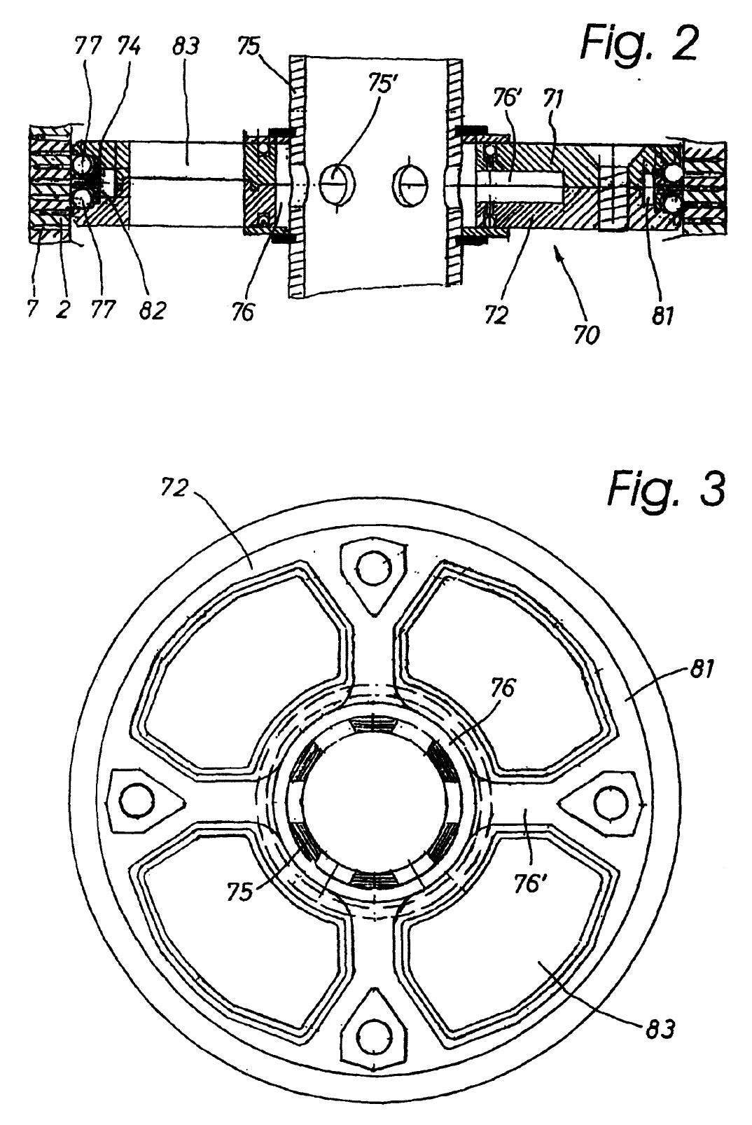

This back-flow device advantageously displays two nozzle bodies 70 arranged in the filter element 8 attached to a hollow shaft 75, which are arranged at a distance from each other. The nozzle bodies 70 which are identical are each provided with nozzle openings 74 distributed over the entire area, pointing radially outwards to the gaps 7, as can also be seen from FIG. 2 and FIG. 3. On the outer perimeter these nozzle bodies 70 are guided around the cylindrical inner sid of the filter element 8 to form a seal, where O-ring seals 77 or similar are provided on both sides of the nozzl openings 74. This means that the liquid flowing through the nozzle openings 74 cannot flow away laterally. Thus, too, by comparison with sand filters, there are no concerns that the backing-up pressure of the liquid used for back-flow could drop.

These two disc-shaped nozzle bodies 70 are mounted together with the hollow shaft 75, in such a way that they are concentric and height-adjustable, in the filter element 8. With these nozzle bodies 70 all gaps 7 in the filter element 8 can be flushed out in sequence. To this end, the hollow shaft 75 is connected via a screw thread with two spindles 76 rotating in the housing 61. For their part, these spindles 78 are actuated via a gearwheel drive 89 or similar by a manual crank 79 located outside the housing, or an actuation motor, not shown in more detail. Furthermore a scraper ring 88 encircling the filter element 8 is assigned to each of the two nozzle bodies 70. These scraper rings 88 are coupled via a rod linkage 86, 87 with the hollow shaft 75 and they are therefore moved up and down during back-flow with the latter. In the starting position they are, as with the nozzle bodies, advantageously pushed upwards.

In the filter of this filter device 60, the liquid, especially contaminated water, is let in at the inlet nozzle 62, until the ring chamber 68 is full and the liquid is forced through the gaps 2 into the interior of the filter element 8. The liquid thus purified then flows away upwards through tho oblique passages 83 of the nozzle bodies 70 at the outlet nozzles 63, where the inlet and outlet nozzles are each attached to a pipe, not shown in more detail. The inlet 64 and the outlet 65 are closed during filtering.

During backflow, when inlet and outlet nozzles 62, 63 are closed, clean liquid is let in through the open inlet 64 into a chamber 69 formed in the upper part of the housing 61 and from this through th holl w shaft 75. The liquid is then sprayed through the openings in the nozzle bodies 70 into the gaps in the filter element 8 and subsequently guided away downwards through the open outlet 65. By means of turning the hand crank 79 during backflow, the nozzle bodies 70 and the scraper rings 88 on the outside are moved down and then up again, in order to clean the gaps and the surface area of the filter element 6 over the entire height. Obviously this back-flow process can be automated so that the valve closure and the movement of the nozzle bodies can occur without manual actuation.

FIG. 2 shows an enlarged view of the nozzle body 70, which is attached to the hollow shaft 75 and displays two disc parts 71, 72 screwed together. Starting from the hollow shaft 75, through-openings 75′, 76, 76′ and a ring chamber 81 are provided through which the liquid is fed to the nozzle openings 74 contained in a ring 82. The ring 82 is now clamped between the disc parts 71, 72. The O-ring seals 77 are arranged at a distance from each other of two ring thicknesses 2. This makes it possible for only the gap 7 corresponding with the nozzle opening 74 to be open, while those adjacent to the O-rings 77 are covered.

FIG. 3 shows the disc part 72 of the nozzle body 70 which is in the form of a wheel and accordingly has four large oblique passages 83 which enable a maximum passage cross-section for the purified liquid in the filter element 8. The through-openings 75′, 76, 76′ open into the ring chamber 81 from which the liquid is guided into the nozzle openings 74, which can be designed as holes distributed over the perimeter or as slots.

According to FIG. 8 the filter element 8 formed from a number of filter rings 2 layered on top of each other is located in the interior of a housing 12 which has a base 14 and a cover 16. This base and cover are braced by threaded rods 18.

The individual filter rings 2 are layered on top of each other into a filter pack, which is supported underneath by a flange 20. Against the upper of the filter packs lies a deck flange 24 pressed against the filter rings by a spring 22. The hollow in the filter pack is pierced by a rod 26, which is supported underneath in a bearing 28. The deck flange 24 and the rod 26 are fixed integrally to each other. The upper rod end is connected to a means of rotary actuation, not described in more detail, for example a manual crank. Underneath the cover 16 there is a gearwheel 30 integrally fixed to the rod 26, which engages in a first pinion 32. This pinion 32 sits integrally fixed on a brush rod 34. An upper journal 36 of the brush rod 34 and a lower journla 38 are each pivoted in a bearing bush 40, 42.

To stabilise the filter rings 2 which are arranged on top of each other at least one support hub 21 is provided, which is centred or fastened internally on the rod 26 and on the outer perimeter is clamped between two filter rings 2. Obviously, depending on the height of the filter pack, there may be several such support hubs 21.

The brush 46 equipped with bristles 44 abuts the perimeter of the filter pack and serves to scrape off the filter residues. The length of the brush 46 is shorter than the length of the filter pack, hence the brush 46 can be moved vertically. To this end, there is a vertical spindle 48 which can be turned by a second pinion 50. A carrier 54 sitting on the brush axis 52 engages in the thread 56 of the spindle 48. When thus the second pinion 50 is turned, the brush 46 slides down the brush axis 52 and is thereby able to scrape the entire height of the filter pack clean of filter residues. When the rod 26 is turned together with the filter pack, the brush axis 52 is also turned by the gearwheels 30 and 32.

The carrying-off of the purified liquid from th hollow of the filter elem nt occurs on the ground through a waste pipe 55. The supply of unpurified liquid into the housing 10 occurs via a pipe not shown in FIG. 8, whereby the inlet is arranged advantageously in the upper part of the housing 12. In order to let out the filter residues, a closable outflow pipe can also be arranged on the ground 14. If necessary, in addition to the brush—or in place of it—a backflow can be provided to cleanse the filter element, thus a liquid movement against the normal direction of filter flow.

One design variant of FIG. 8 consists in designing the brush 46 of a length such that it extends over the entire height of the filter element. This makes the spindle 48 unnecessary. Otherwise the structure and mode of action are identical to the description in connection with FIG. 8.

As can be seen from FIG. 9, one such vriant with a brush 46, with a brush axle 52 and helically-arranged bristles 44 can be provided, which advantageously extends over the entire height of the filter element 8. The direction of rotation of the brush 46 is selected such that the helical bristles are in contact with the outer sheath of the filter element from top to bottom and that the material brushed off is removed by suction.

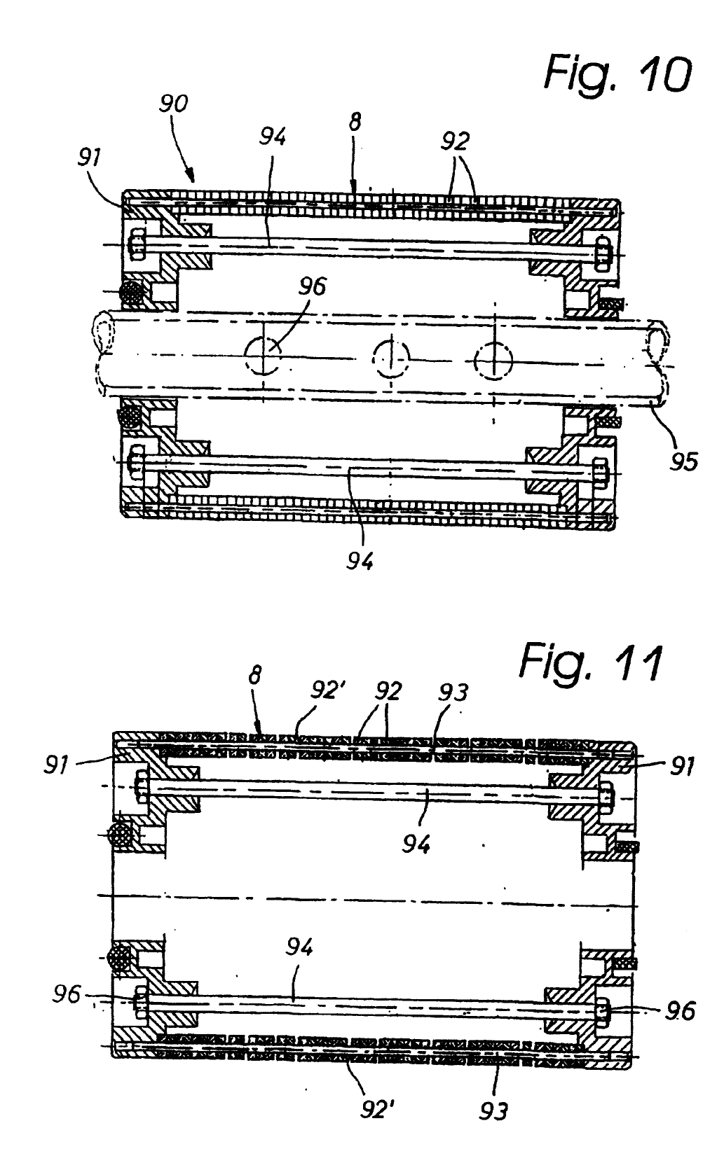

FIG. 10 shows a filter device 90, of which the filter element 8 and the centring sheaths 91 holding this on both sides are shown. This filter element 8 and obviously contained in a housing, not shown in more detail, similar to that according to FIG. 8 and said filter element is composed of a number of filter rings 92 which are formed identically to those according to FIG. 4 and FIG. 5, with the sole difference that these are each provided with two diametrically opposed through-openings 92′. These latter make it possible for a guide rod 93 with both ends movably mounted on the centring sleeves 91 to project through these through-openings 92′. The centring sleeves 91 for their part are held so as to be axially adjustabl on two diametrically opposed rods 94. Also indicated is a pipe conduit 95 arranged concentrically in the filter element 8 with radial openings 96, through which the purified liquid escapes.

FIG. 11 shows the filter device 90 in the cleaning position, in which one centring sleeve 91 is pushed away from the other. At the ends of the rod 94 are fixed screws 96 or similar which serve as limit stops for the displaced centring sleeves 91 against each other. In this released position, these filter rings 92 are held loosely against each other on the guide rod 93, so that the cleaning liquid passed between them can completely clean in particular these faces of the rings 92 forming the gaps.

The invention is sufficiently demonstrated by the design examples explained above. In principle, the gaps could also be designed such that the liquid in the filter element would be led from the interior to the exterior. A back-flow device could also in principle be provided with a nozzle body arranged outside the filter element, which would surround the filter element as a ring and in which the nozzle openings would advantageously point radially inwards.

The filter rings could also display an external form other than that illustrated, for example polygonal or similar.

1. Filter device, especially for a liquid, with a filter element (8) through which the unfiltered liquid is passed for purification, characterised in that the filter element displays a number of filter rings (2) lying loosely on top of each other, which are designed in such a way that when stacked up they lie on top of each other and form gaps (7) in between to allow the liquid through.

2. Filter device according to one of the preceding claims characterised in that the filter rings (2) arranged concentrically on top of each other are designed so as to be self-centring.

3. Filter device according to claim 1, characterised in that the filter rings (2) contain on their faces a number of cams (3) and diametrically opposed recesses (4), and that in between them there are gaps (7) preferably extending towards the centre of the ring, where the dimensions of the cams (3) lying flush on top of each other and recesses (4) define the height of the gap (7).

4. Filter device according to one of the preceding claims characterised in that the filter element (8) is contained in a housing (10, 61) which has at least one inlet and one outlet, where the contaminated liquid can be passed from outside into the interior of the filter element (8) and pass out of the housing (10, 61) in purified condition.

5. Filter device according to one of the preceding claims characterised in that the filter element (8) has a back-flow device by means of which the contaminant deposited in the gaps (7) is removed.

6. Filter device according to claim 5, characterised in that the back-flow device displays at least one nozzle body (70) arranged in the filter element (8) attached to a hollow shaft (75), which is equipped with nozzle openings (74) distributed over the entire area pointing radially outwards into the gaps (7), where the hollow shaft (75) and the nozzle bodies (70) are height-adjustable, mounted in the housing (61), so that the nozzle body (70) can flush out all the gaps (7) in the filter element (8) in sequence.

7. Filter device according to claim 6, characterised in that the respective disc-shaped nozzle body (70) together with the hollow shaft (75), is coaxially mounted in the filter element (8) and is guided with its external perimeter around the cylindrical inner side (8′) of the filter element (8) forming a seal, where O-ring seals (77) or similar are provided on both sides of the nozzle openings (74).

8. Filter device according to claim 6 or 7, characterised in that in the hollow shaft (75) and in the nozzle bodies (70) attached thereto, through-openings (75′, 76, 76′) and a ring chamber (81) are provided, through which the liquid is conducted from the hollow shaft (75) to the nozzle openings (74).

9. Filter device according to one of the preceding claims 1 to 8, characterised in that the filter element (8) consisting of filter rings (2) stacked on top of each other is connected with an axially-running rod (26) and on the outside of the filter element (8) there is at least one brush (46), which services to scrape off the filter residues, and filter element (8) and brush (46) are adjustable relative to each other and at least the brush (46) can pivot about its own axis.

10. Filter device according to one of the preceding claims, characterised in that to stabilise the filter rings (2) stacked on top of each other, at least on support hub (21) is provided, which is centred or attached on the inside to the rod (26) and on the outer perimeter is clamped in between two filter rings (2).

11. Filter device according to on of th preceding claims 1 to 9, characterised in that the filter rings (92) are adjustable from an operating position in which they are arranged lying flush on top of each other, into a released position, in which they are distanced from each other, so that the filter rings (92) can be completely cleaned.

12. Filter device according to claim 11, characterised in that the filter rings (92) are each fitted with at least one through-hole (92′) through each of which a guide rod (93) projects, which guide rods in turn are attached at both ends to a centring sleeve (91) holding the filter element (8), which are movable from the operating to the released position.

13. Filter device according to one of the preceding claims 1 to 9, characterised in that the filter rings (92) are formed all of a piece and consist of plastic, preferably of a PVC or ABS material.
